(19) United States
(12) Patent Application Publication
(10) Pub. No.: US 2026/0303207 A1
(43) Pub. Date: Oct. 1, 2026

(54) SIMULATED LIGHT SOURCE GENERATION DEVICE, SIMULATED LIGHT SOURCE GENERATION METHOD, AND RECORDING MEDIUM

(71) Applicant: NEC Corporation, Tokyo (JP)

(72) Inventors: Tatsuro MAKI, Tokyo (JP); Akihiko KATO, Tokyo (JP); Hiroyuki TOYAMA, Tokyo (JP); Tadayoshi INUMARU, Tokyo (JP)

(73) Assignee: NEC Corporation, Tokyo (JP)

(21) Appl. No.: 19/400,579

(22) Filed: Nov. 25, 2025

(30) Foreign Application Priority Data
Mar. 26, 2025 (JP) 2025-051052

(51) Int. Cl. H04B 10/077; H04B 10/112

(52) U.S. Cl. CPC H04B 10/0775; H04B 10/112

(57) ABSTRACT

An acquisition unit acquires an atmospheric parameter representing a certain atmospheric condition, an input unit inputs the acquired atmospheric parameter to a model that has learned wavefronts of laser light observed under a plurality of atmospheric conditions, and a generation unit generates, based on a wavefront output from the model, a pseudo wavefront of laser light observed under the certain atmospheric condition.

This application is based upon and claims the benefit of priority from Japanese patent application No. 2025-051052, filed on Mar. 26, 2025, the disclosure of which is incorporated herein in its entirety by reference.

### TECHNICAL FIELD

The present disclosure relates to a simulated light source generation device, a simulated light source generation method, and a recording medium, and relates to a simulated light source generation device, a simulated light source generation method, and a recording medium for generating a pseudo wavefront of a light source.

### BACKGROUND ART

A related corrective optical system described in WO 2020/100360 A1 includes a wavefront correction optical system, a sensor, and a control device. The wavefront correction optical system corrects a wavefront of light passing through a predetermined optical path. The sensor acquires environmental information in the optical path. The control device predicts wavefront disturbance of the light passing through the optical path based on the environmental information, and controls the wavefront correction optical (adaptive optics (AO)) system so as to cancel the predicted wavefront disturbance. As a result, the related corrective optical system performs optical correction based on a result of artificial intelligence (AI) learning performed in advance using learning data including measurement data.

### SUMMARY

Methods for examining an influence of disturbance on laser light include a field demonstration and a laboratory test. The test needs to be performed under various atmospheric conditions. Such a related technology requires enormous time and effort.

The present disclosure has been made in view of the above problems, and an object thereof is to reduce time and effort required for a test for inspecting an influence of disturbance on laser communication.

A simulated light source generation device according to one aspect of the present disclosure includes: an acquisition means for acquiring an atmospheric parameter representing a certain atmospheric condition; an input means for inputting the acquired atmospheric parameter to a model that has learned wavefronts of laser light observed under a plurality of atmospheric conditions; and a generation means for generating, based on a wavefront output from the model, a pseudo wavefront of laser light observed under the certain atmospheric condition.

In a simulated light source generation method according to one aspect of the present disclosure, a computer executes: a step of acquiring an atmospheric parameter representing a certain atmospheric condition; a step of inputting the acquired atmospheric parameter to a model that has learned wavefronts of laser light observed under a plurality of atmospheric conditions; and a step of generating, based on a wavefront output from the model, a pseudo wavefront of laser light observed under the certain atmospheric condition.

A recording medium according to one aspect of the present disclosure stores a program for causing a computer to execute: processing of acquiring an atmospheric parameter representing a certain atmospheric condition; processing of inputting the acquired atmospheric parameter to a model that has learned wavefronts of laser light observed under a plurality of atmospheric conditions; and processing of generating, based on a wavefront output from the model, a pseudo wavefront of laser light observed under the certain atmospheric condition.

According to one aspect of the present disclosure, it is possible to reduce time and effort required for a test for inspecting an influence of disturbance on laser communication.

### BRIEF DESCRIPTION OF THE DRAWINGS

FIG. 1 schematically illustrates an example of a system according to one example embodiment;

FIG. 2 is a block diagram illustrating a configuration of a simulated light source generation device according to the one example embodiment;

FIG. 3 illustrates an example of a wavefront in a case where laser light (light source) passes through adaptive optics (AO) that simulates an influence of atmospheric turbulence;

FIG. 4 is a flowchart illustrating an operation of the simulated light source generation device according to the one example embodiment;

FIG. 5 is a block diagram illustrating a configuration of a simulated light source generation device according to one example embodiment;

FIG. 6 illustrates a method for generating training data (wavefronts & atmospheric parameters) for a model to learn;

FIG. 7 is a flowchart illustrating an operation of the simulated light source generation device according to the one example embodiment;

FIG. 8 illustrates a method for increasing the training data (wavefronts & observation parameters) for the model to learn by using adaptive optics;

FIG. 9 is a flowchart illustrating an operation of the simulated light source generation device according to the one example embodiment; and

FIG. 10 illustrates an example of a hardware configuration of the simulated light source generation device according to the one example embodiment.

### EXAMPLE EMBODIMENT

Some example embodiments of the present disclosure will be described below with reference to the drawings.

### First Example Embodiment

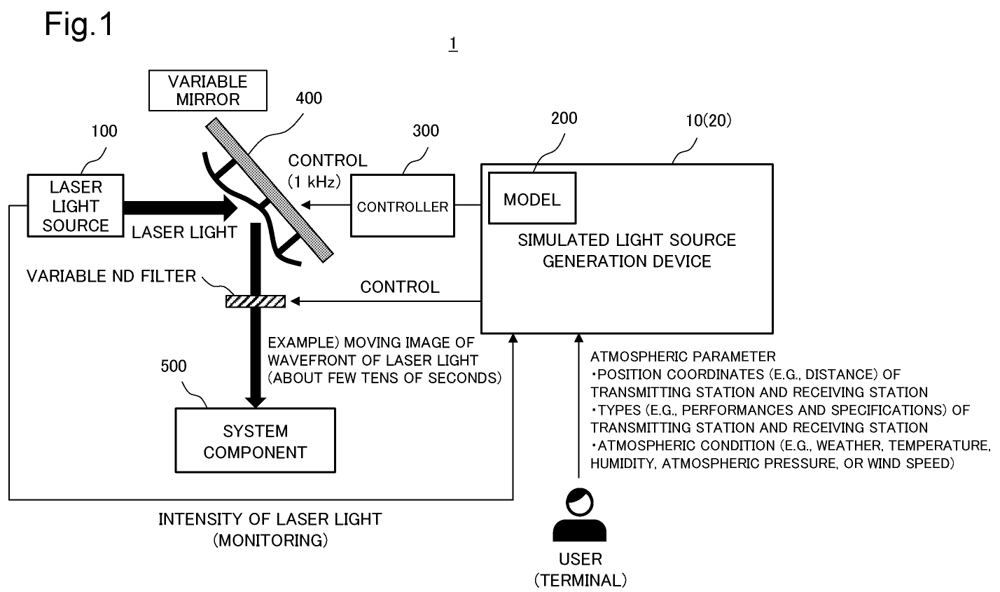

A first example embodiment of the present disclosure will be described with reference to FIGS. 1 to 4.

### Example of Inspection System 1

FIG. 1 schematically illustrates an example of an inspection system 1 according to the first example embodiment of the present disclosure. As illustrated in FIG. 1, the inspection system 1 includes a simulated light source generation device 10 (20), a laser light source 100, a model 200, a controller 300, and a communication system component 500. The simulated light source generation device 10 (20) may include the model 200. Here, the “simulated light source generation device 10 (20)” means “the simulated light source generation device 10 according to the present first example embodiment, or the simulated light source generation device 20 according to a second example embodiment to be described later”.

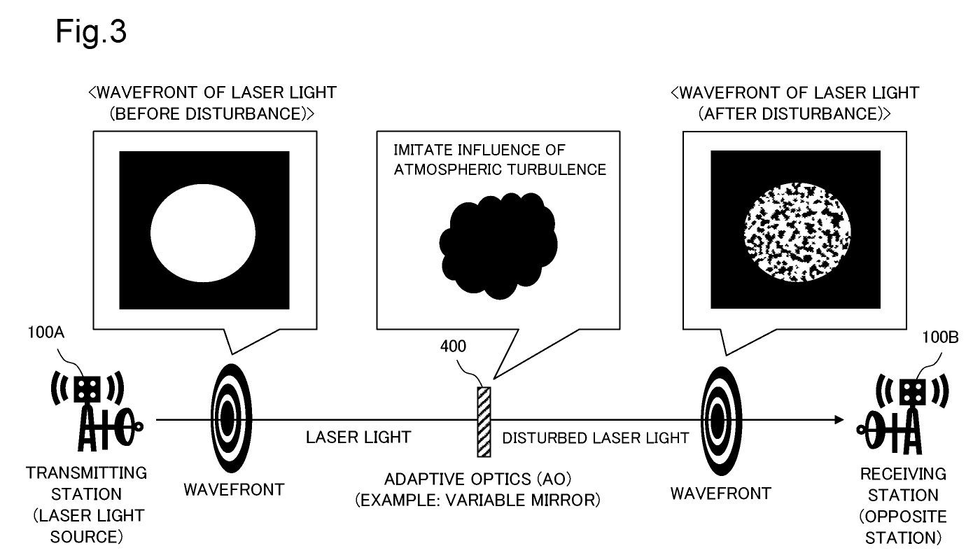

The laser light source 100 includes a transmitting station 100A (FIG. 3) and a receiving station (opposite station) 100B (FIG. 3) to be described later. The model 200 is a program trained using a large-scale data set (training data) for a certain task by a technology such as deep learning.

Here, the training data is wavefronts of laser light observed under various atmospheric conditions. The model 200 is trained in advance to output, when a certain atmospheric condition is set (input), a wavefront of pseudo laser light predicted to be observed under the certain atmospheric condition.

The inspection system 1 is configured to perform a performance test of the communication system component 500. The component 500 includes the transmitting station (laser light source) 100A (FIG. 3) and the receiving station (opposite station) 100B (FIG. 3) to be described later for laser light.

### Configuration of Simulated Light Source Generation Device 10

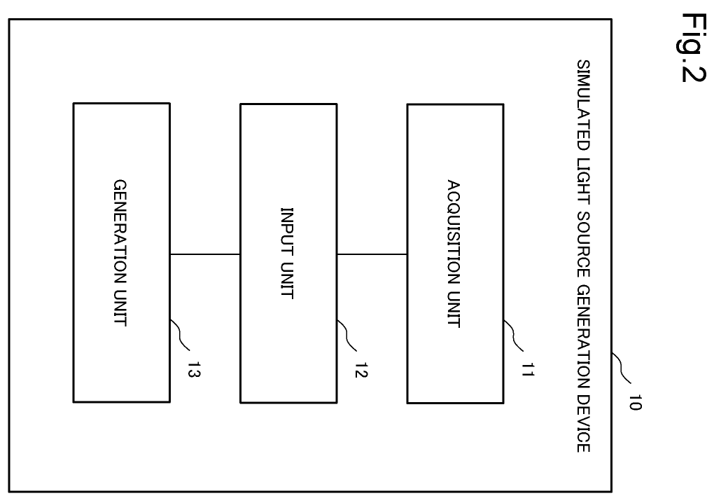

FIG. 2 is a block diagram illustrating a configuration of the simulated light source generation device 10 according to the present first example embodiment. As illustrated in FIG. 2, the simulated light source generation device 10 includes an acquisition unit 11, an input unit 12, and a generation unit 13.

The acquisition unit 11 acquires an atmospheric parameter representing a certain atmospheric condition to be input to the trained model 200 (FIG. 1). The acquisition unit 11 is an example of an acquisition means. Here, in an example, the atmospheric parameter is position coordinates (e.g., distance) of the transmitting station 100A (FIG. 3) and the receiving station 100B (FIG. 3). In another example, the atmospheric parameter is types (e.g., performances and specifications) of the transmitting station 100A (FIG. 3) and the receiving station 100B (FIG. 3). In still another example, the atmospheric parameter is an atmospheric condition (e.g., weather, temperature, humidity, atmospheric pressure, or wind speed) particularly in a vicinity of the receiving station 100B (FIG. 3).

For example, the acquisition unit 11 receives an input of an atmospheric parameter from a user terminal (FIG. 1). Alternatively, the acquisition unit 11 may acquire, as the atmospheric parameter, information indicating a real-time atmospheric condition (e.g., weather, temperature, humidity, atmospheric pressure, or wind speed) from a meteorological observatory or the like.

The acquisition unit 11 outputs the acquired atmospheric parameter to the input unit 12.

The input unit 12 inputs the atmospheric parameter acquired by the acquisition unit 11 to the model 200 that has learned wavefronts of laser light observed under a plurality of atmospheric conditions. The input unit 12 is an example of an input means.

For example, the input unit 12 receives the atmospheric parameter from the acquisition unit 11. The input unit 12 inputs the atmospheric parameter acquired from the acquisition unit 11 to the model 200.

Based on an acquired wavefront, the generation unit 13 generates a pseudo wavefront of laser light observed under a certain atmospheric condition. The generation unit 13 is an example of a generation means.

For example, the generation unit 13 acquires a pseudo wavefront of laser light output from the model 200 to which the atmospheric parameter has been input. The pseudo wavefront output from the model 200 is predicted to be observed under the certain atmospheric condition. In a case where the model 200 has been trained in advance using sufficient training data (that is, wavefronts of laser light observed under various atmospheric conditions), it is considered that accuracy of the prediction can be inferred.

Specifically, the generation unit 13 causes the controller 300 to control adaptive optics 400 (FIG. 1) based on the output from the model 200 to generate a pseudo wavefront of laser light predicted to be observed under a certain atmospheric condition. An example of a test of the communication system component 500 is described below.

### Example of Test of Communication System Component 500

FIG. 3 illustrates an example of a test of the communication system component 500 (FIG. 1). Here, a test of the transmitting station 100A and the receiving station 100B will be described as an example. The transmitting station 100A and the receiving station 100B are examples of the component 500 constituting a communication system.

In an example of the test illustrated in FIG. 3, first, laser light having a predetermined output value is emitted from the transmitting station 100A. As illustrated in FIG. 3, the laser light emitted from the transmitting station 100A is incident on the adaptive optics 400. The adaptive optics 400 includes a variable mirror (FIG. 1). An orientation and a shape of the variable mirror of the adaptive optics 400 are controlled by the controller 300 (FIG. 1).

Intensity of laser light emitted from the laser light source 100 is monitored by the simulated light source generation device 10. The simulated light source generation device 10 adjusts the intensity of the laser light emitted from the laser light source 100 by using a variable neutral density (ND) filter (FIG. 1) or the like so as to maintain a constant intensity (predetermined output value) of the laser light incident on the communication system component 500.

The laser light that has passed through the adaptive optics 400 reproduces a pseudo wavefront of laser light predicted to be observed under a certain atmospheric condition (disturbed laser light in FIG. 3).

The receiving station (opposite station) 100B receives the pseudo disturbed laser light. For example, an absolute value of the intensity of the pseudo disturbed laser light received by the receiving station (opposite station) 100B, magnitude (deviation) of a change in the intensity, and the like are tested.

### Operation of Simulated Light Source Generation Device 10

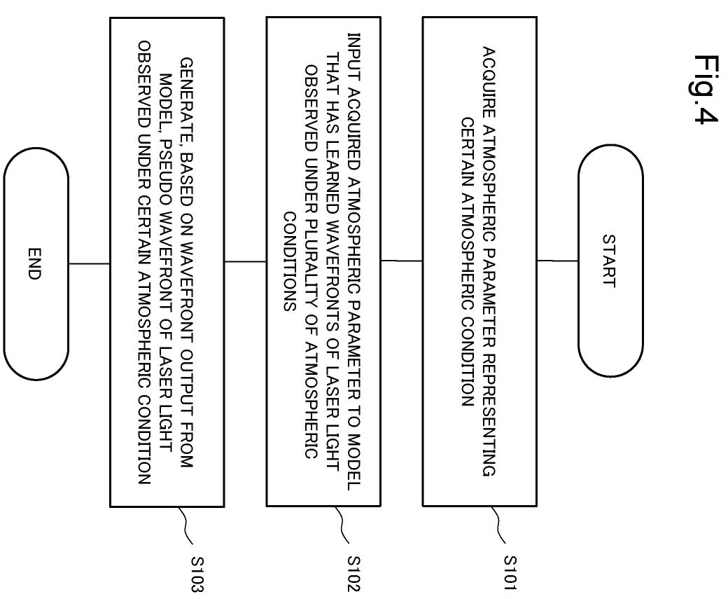

FIG. 4 illustrates an operation of the simulated light source generation device 10 according to the present first example embodiment. FIG. 4 is a flowchart illustrating the operation of the simulated light source generation device 10.

As illustrated in FIG. 4, first, the acquisition unit 11 acquires an atmospheric parameter representing a certain atmospheric condition (S101).

Next, the input unit 12 inputs the atmospheric parameter acquired by the acquisition unit 11 to the model 200 (FIG. 1) that has learned wavefronts of laser light observed under a plurality of atmospheric conditions (S102).

Thereafter, based on a wavefront output from the model 200, the generation unit 13 generates a pseudo wavefront (FIG. 3) of laser light observed under the certain atmospheric condition (S103).

This ends the operation of the simulated light source generation device 10 according to the present first example embodiment.

### Effects of Present Example Embodiment

According to the configuration of the present example embodiment, the acquisition unit 11 acquires an atmospheric parameter representing a certain atmospheric condition, the input unit 12 inputs the acquired atmospheric parameter to the model 200 that has learned wavefronts of laser light observed under a plurality of atmospheric conditions, and the generation unit 13 generates, based on a wavefront output from the model 200, a pseudo wavefront of laser light observed under the certain atmospheric condition.

In this way, the pseudo wavefront of the laser light observed under the certain atmospheric condition is obtained. Thus, it is not necessary to perform a field or laboratory test in order to obtain an actual wavefront of the laser light observed under the certain atmospheric condition. As a result, it is possible to reduce time and effort required for a test for inspecting an influence of disturbance on laser communication.

### Second Example Embodiment

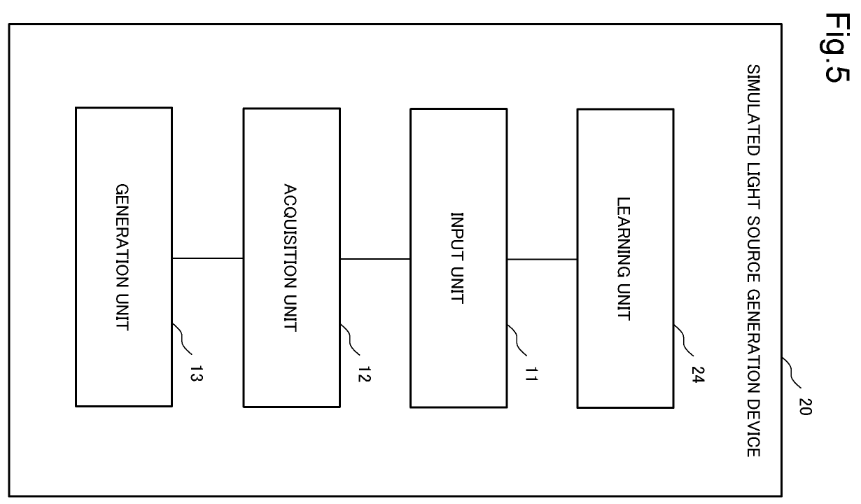

The second example embodiment of the present disclosure will be described with reference to FIGS. 5 to 9. In the present second example embodiment, the same components as those in the first example embodiment are denoted by the same reference numerals as those in the first example embodiment, and the description thereof will be omitted.

### Configuration of Simulated Light Source Generation Device 20

FIG. 5 is a block diagram illustrating a configuration of the simulated light source generation device 20 according to the present second example embodiment. As illustrated in FIG. 5, the simulated light source generation device 20 includes an acquisition unit 11, an input unit 12, and a generation unit 13. The simulated light source generation device 20 further includes a learning unit 24.

The learning unit 24 trains the model 200 (FIG. 1) of machine learning by causing the model 200 to learn wavefronts of laser light observed under a plurality of atmospheric conditions and atmospheric parameters individually representing the atmospheric conditions. The learning unit 24 is an example of a learning means.

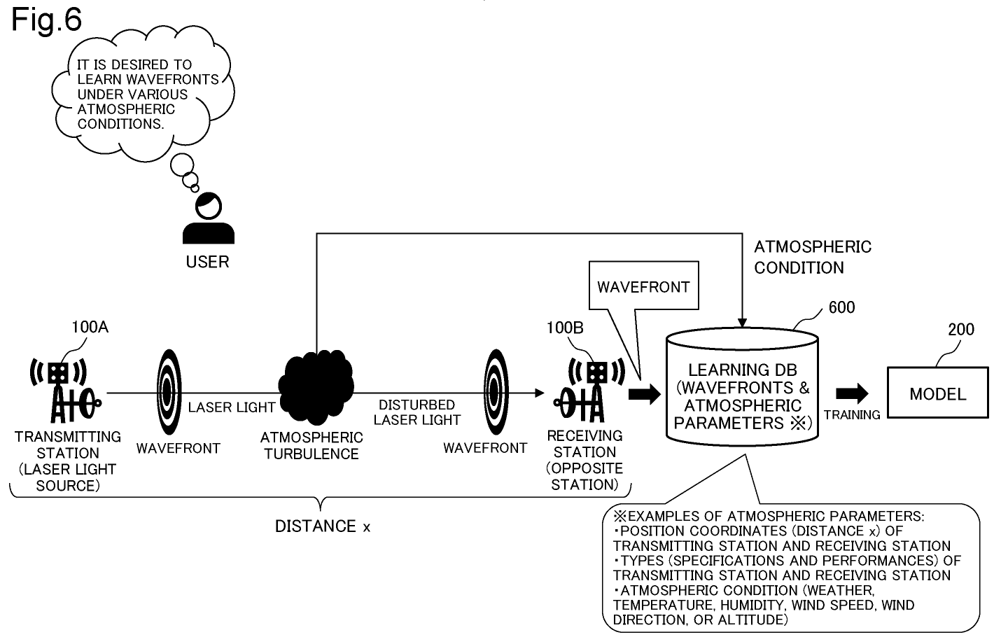

For example, the atmospheric parameters are position coordinates (distance x) of a transmitting station 100A (FIG. 6) and a receiving station 100B (FIG. 6), types (performances) of the transmitting station 100A and the receiving station 100B, and an atmospheric condition (weather, temperature, humidity, wind speed, wind direction, or altitude) at the time of observation.

### Example of Learning Method of Model 200

An example of a learning method of the model 200 by the learning unit 24 will be described with reference to FIG. 6.

As illustrated in FIG. 6, a user observes laser light disturbed by atmospheric turbulence or the like (disturbed laser light) under a plurality of atmospheric conditions. Then, the user stores wavefronts of the observed disturbed laser light and atmospheric parameters individually representing the atmospheric conditions in a learning database (DB) 600 (FIG. 6). The learning unit 24 executes training of the model 200 by using the wavefronts and the atmospheric parameters stored in the learning DB 600.

As a result, the trained model 200 (FIG. 1) can be obtained.

### Operation of Simulated Light Source Generation Device 20

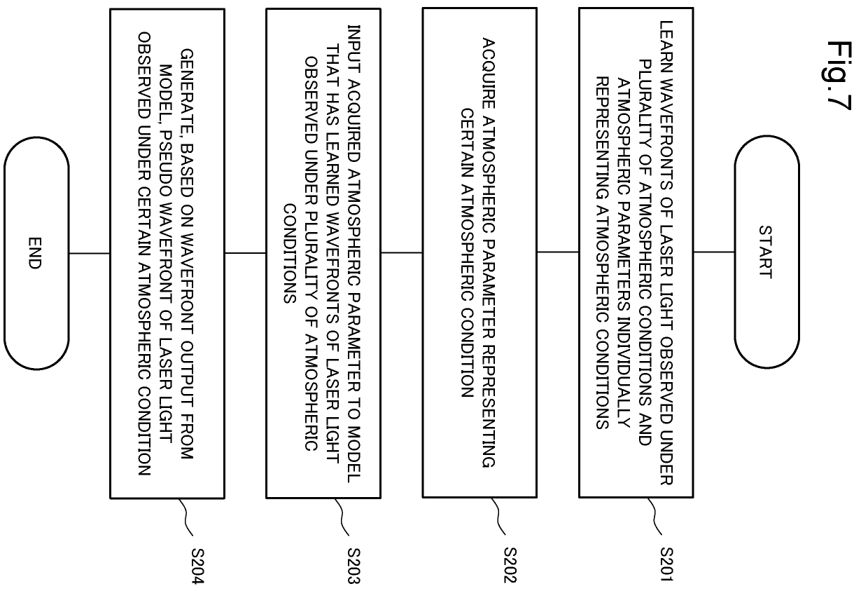

An operation of the simulated light source generation device 20 according to the present second example embodiment will be described with reference to FIG. 7.

As illustrated in FIG. 7, first, the learning unit 24 causes the model 200 to learn wavefronts of laser light observed under a plurality of atmospheric conditions and atmospheric parameters individually representing the atmospheric conditions (S201).

After completion of training of the model 200, the acquisition unit 11 acquires an atmospheric parameter representing a certain atmospheric condition (S202).

Subsequently, the input unit 12 inputs the atmospheric parameter acquired by the acquisition unit 11 to the model 200 (FIG. 1) that has learned the wavefronts of the laser light observed under the plurality of atmospheric conditions (S203).

Thereafter, based on a wavefront output from the model 200, the generation unit 13 generates a pseudo wavefront (FIG. 3) of laser light observed under the certain atmospheric condition (S204).

This ends the operation of the simulated light source generation device 20 according to the present second example embodiment.

### MODIFICATION

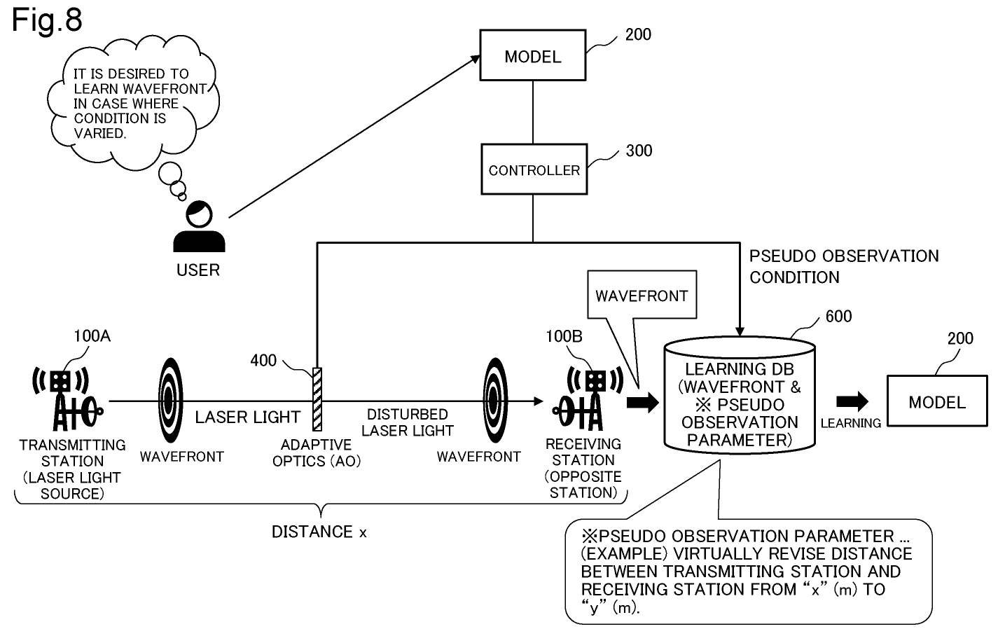

One modification of the present second example embodiment will be described with reference to FIG. 8. The present modification considers a case where a user wants the model 200 to additionally learn a wavefront in a case where performances of a transmitting station 100A (FIG. 8) and a receiving station 100B (FIG. 8) or an observation condition such as an atmospheric condition is varied.

In the one modification, the user determines an observation parameter representing a pseudo observation condition, and inputs the observation parameter to the simulated light source generation device 20. For example, the pseudo observation condition is that the distance between the transmitting station 100A and the receiving station 100B is different from that the model 200 has learned. In an example, the user revises the distance between the transmitting station 100A and the receiving station 100B from the actual “x” (m) to a virtual “y” (m).

The learning unit 24 inputs the observation parameter representing the pseudo observation condition to the model 200, and causes the model 200 to output a pseudo wavefront of disturbed laser light.

The pseudo wavefront of the laser light that has been generated is utilized, for example, to test the performance of the communication system component 500 (FIG. 1) using laser light.

### Flow of Additional Learning in One Modification

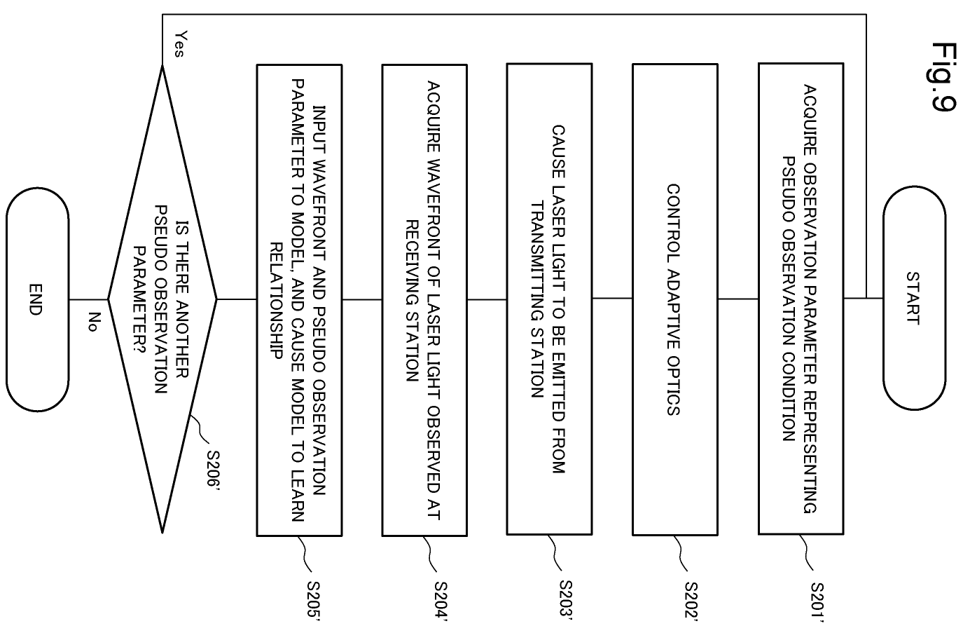

A flow of additional learning in the above-described one modification will be described with reference to FIG. 9. FIG. 9 is a flowchart illustrating a flow of processing executed by the learning unit 24 (and a user) of the simulated light source generation device 20.

First, the user sets an observation parameter representing a pseudo observation condition.

As illustrated in FIG. 9, the learning unit 24 acquires the observation parameter set by the user, and inputs the observation parameter to the model 200. The model 200 outputs a wavefront corresponding to the observation parameter set by the user. The learning unit 24 acquires the observation parameter representing the pseudo observation condition (S201').

The learning unit 24 controls adaptive optics 400 (FIG. 8) in accordance with the observation parameter representing the pseudo observation condition (S202').

The learning unit 24 causes laser light to be emitted from the transmitting station 100A (FIG. 8) (S203').

The learning unit 24 acquires a wavefront of the laser light observed at the receiving station 100B (FIG. 8) (S204').

The learning unit 24 inputs the acquired wavefront and the pseudo observation parameter to the model 200, and causes the model 200 to learn a relationship (S205').

Thereafter, an input of an observation parameter representing another pseudo observation condition is received from the user.

If the user desires to revise the pseudo observation parameter to the another pseudo observation parameter (Yes in S206'), the flow returns to step S201'.

On the other hand, if the user does not desire to revise the pseudo observation parameter to the another pseudo observation parameter (No in S206'), an operation of the learning unit 24 according to the present modification ends.

### Effects of Present Example Embodiment

According to the configuration of the present example embodiment, the learning unit 24 trains the model 200 of machine learning by causing the model 200 to learn wavefronts of laser light observed under a plurality of atmospheric conditions and atmospheric parameters individually representing the atmospheric conditions. The acquisition unit 11 acquires an atmospheric parameter representing a certain atmospheric condition, the input unit 12 inputs the acquired atmospheric parameter to the model 200 that has learned the wavefronts of the laser light observed under the plurality of atmospheric conditions, and the generation unit 13 generates, based on a wavefront output from the model 200, a pseudo wavefront of laser light observed under the certain atmospheric condition.

In this way, the pseudo wavefront of the laser light observed under the certain atmospheric condition is obtained. Thus, it is not necessary to perform a field or laboratory test in order to obtain an actual wavefront of the laser light observed under the certain atmospheric condition. As a result, it is possible to reduce time and effort required for a test for inspecting an influence of disturbance on laser communication.

### Example of Hardware Configuration

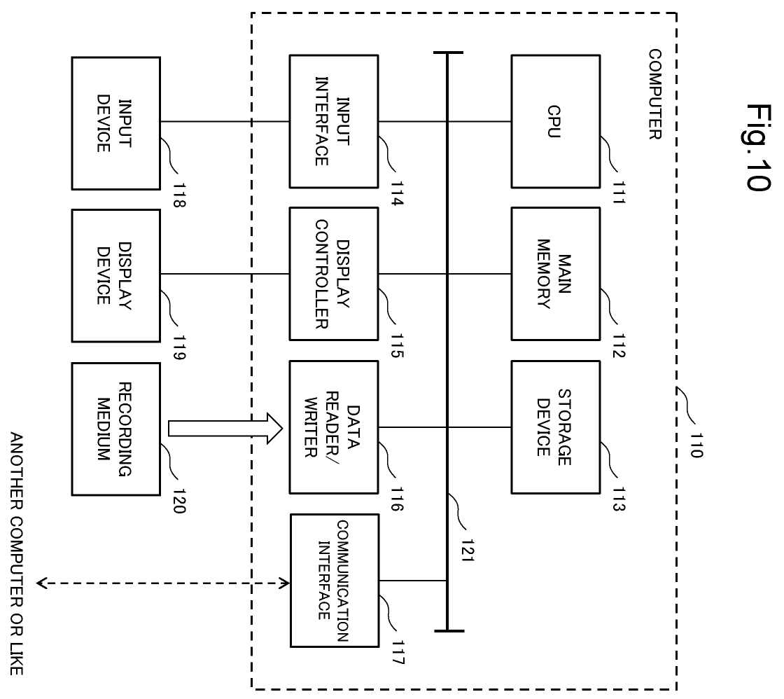

Each component of the simulated light source generation devices 10 and 20 described in the first and second example embodiments represents a block of a functional unit. Some or all of these components are achieved by, for example, an information processing device as illustrated in FIG. 10. FIG. 10 is a block diagram illustrating an example of a hardware configuration of the information processing device.

As illustrated in FIG. 10, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a graphics processing unit (GPU) or a field-programmable gate array (FPGA) in addition to the CPU 111 or instead of the CPU 111.

The CPU 111 loads the programs (codes) in the present example embodiment, which are stored in the storage device 113, into the main memory 112, and executes them in a predetermined order to perform various operations. The main memory 112 is typically a volatile storage device such as a dynamic random access memory (DRAM). The programs in the present example embodiment are provided in a state of being stored in a computer-readable recording medium 120. The programs in the present example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

### Supplementary Note

Some or all of the example embodiments described above may also be described as, but are not limited to, the following Supplementary Notes.

### Supplementary Note 1

A simulated light source generation device including:
an acquisition means for acquiring an atmospheric parameter representing a certain atmospheric condition;
an input means for inputting the acquired atmospheric parameter to a model that has learned wavefronts of laser light observed under a plurality of atmospheric conditions; and a generation means for generating, based on a wavefront output from the model, a pseudo wavefront of laser light observed under the certain atmospheric condition.

### Supplementary Note 2

The simulated light source generation device according to Supplementary Note 1, further including:
a learning means for training a model of machine learning by causing the model to learn the wavefronts of the laser light observed under the plurality of atmospheric conditions and atmospheric parameters individually representing the atmospheric conditions.

### Supplementary Note 3

The simulated light source generation device according to Supplementary Note 2, in which
the learning means inputs an atmospheric parameter representing a pseudo atmospheric condition to the model, and causes the model to output a pseudo wavefront of disturbed laser light.

### Supplementary Note 4

The simulated light source generation device according to Supplementary Note 3, in which
the generation means controls adaptive optics to generate the pseudo wavefront of the disturbed laser light.

### Supplementary Note 5

The simulated light source generation device according to any one of Supplementary Notes 1 to 4, in which
the generated pseudo wavefront of the laser light is utilized to test a performance of a communication system component using laser light.

### Supplementary Note 6

The simulated light source generation device according to Supplementary Note 1, in which the atmospheric parameter includes
at least one of:
a distance between a transmitting station and a receiving station for laser light;
types or performances of the transmitting station and the receiving station; and
weather information.

### Supplementary Note 7

A simulated light source generation method executed by a computer, the simulated light source generation method including:
a step of acquiring an atmospheric parameter representing a certain atmospheric condition;
a step of inputting the acquired atmospheric parameter to a model that has learned wavefronts of laser light observed under a plurality of atmospheric conditions; and
a step of generating, based on a wavefront output from the model, a pseudo wavefront of laser light observed under the certain atmospheric condition.

### Supplementary Note 8

The simulated light source generation method according to Supplementary Note 7, further including:a step of, by the computer, training a model of machine learning by causing the model to learn the wavefronts of the laser light observed under the plurality of atmospheric conditions and atmospheric parameters individually representing the atmospheric conditions.

### Supplementary Note 9

A program for causing a computer to execute:
processing of acquiring an atmospheric parameter representing a certain atmospheric condition;
processing of inputting the acquired atmospheric parameter to a model that has learned wavefronts of laser light observed under a plurality of atmospheric conditions; and
processing of generating, based on a wavefront output from the model, a pseudo wavefront of laser light observed under the certain atmospheric condition.

### Supplementary Note 10

The program according to Supplementary Note 9, in which
the computer is caused to further execute processing of training a model of machine learning by causing the model to learn the wavefronts of the laser light observed under the plurality of atmospheric conditions and atmospheric parameters individually representing the atmospheric conditions.

Some or all of the configurations described in Supplementary Notes 2 to 6 dependent on the above-described Supplementary Note 1 (ex. simulated light source generation device) can also be dependent on Supplementary Note 7 (ex. simulated light source generation method) and Supplementary Note 9 (ex. program) by the same dependency relationship as Supplementary Notes 2 to 6. Some or all of the configurations described as Supplementary Notes can be similarly dependent on various pieces of hardware and software, a variety of recording means for recording software, or systems without departing from the above-described example embodiments.

The present disclosure has been particularly shown and described with reference to several example embodiments thereof. However, the present disclosure is not limited to these example embodiments. Each example embodiment can be appropriately combined with other example embodiments. It will be understood by those of ordinary skill in the art that various changes in form and details of these example embodiments may be made therein without departing from the spirit and scope of the present disclosure as defined by the claims.

The invention according to the present disclosure can be used, for example, to inspect a communication system component using laser light.

1. A simulated light source generation device comprising:
a memory configured to store instructions; and
at least one processor configured to execute the instructions to perform:
acquiring an atmospheric parameter representing a certain atmospheric condition;
inputting the acquired atmospheric parameter to a model that has learned wavefronts of laser light observed under a plurality of atmospheric conditions; and
generating, based on a wavefront output from the model, a pseudo wavefront of laser light observed under the certain atmospheric condition.

2. The simulated light source generation device according to claim 1, wherein
the at least one processor is further configured to execute the instructions to perform:
training a model of machine learning by causing the model to learn the wavefronts of the laser light observed under the plurality of atmospheric conditions and atmospheric parameters individually representing the atmospheric conditions.

3. The simulated light source generation device according to claim 2, wherein
the at least one processor is configured to execute the instructions to perform:
inputting an atmospheric parameter representing a pseudo atmospheric condition to the model, and causes the model to output a pseudo wavefront of disturbed laser light.

4. The simulated light source generation device according to claim 3, wherein
the at least one processor is configured to execute the instructions to perform:
controlling adaptive optics to generate the pseudo wavefront of the disturbed laser light.

5. The simulated light source generation device according to claim 1, wherein
the generated pseudo wavefront of the laser light is utilized to test a performance of a communication system component using laser light.

6. The simulated light source generation device according to claim 1, wherein
the atmospheric parameter includes
at least one of:
a distance between a transmitting station and a receiving station for laser light;
types or performances of the transmitting station and the receiving station; and
weather information.

7. A simulated light source generation method executed by a computer, the simulated light source generation method comprising:
a step of acquiring an atmospheric parameter representing a certain atmospheric condition;
a step of inputting the acquired atmospheric parameter to a model that has learned wavefronts of laser light observed under a plurality of atmospheric conditions; and
a step of generating, based on a wavefront output from the model, a pseudo wavefront of laser light observed under the certain atmospheric condition.

8. The simulated light source generation method according to claim 7, further comprising:
a step of, by the computer, training a model of machine learning by causing the model to learn the wavefronts of the laser light observed under the plurality of atmospheric conditions and atmospheric parameters individually representing the atmospheric conditions.

9. The simulated light source generation method according to claim 8, further comprising:
by the computer, inputting an atmospheric parameter representing a pseudo atmospheric condition to the model, and causing the model to output a pseudo wavefront of disturbed laser light.

10. The simulated light source generation method according to claim 9, further comprising:
by the computer, controlling adaptive optics to generate the pseudo wavefront of the disturbed laser light.

11. The simulated light source generation method according to claim 7, wherein
the generated pseudo wavefront of the laser light is utilized to test a performance of a communication system component using laser light.

12. The simulated light source generation method according to claim 7, wherein
the atmospheric parameter includes
at least one of:
a distance between a transmitting station and a receiving station for laser light;
types or performances of the transmitting station and the receiving station; and
weather information.

13. A non-transitory recording medium storing a program for causing a computer to execute:
processing of acquiring an atmospheric parameter representing a certain atmospheric condition;
processing of inputting the acquired atmospheric parameter to a model that has learned wavefronts of laser light observed under a plurality of atmospheric conditions; and
processing of generating, based on a wavefront output from the model, a pseudo wavefront of laser light observed under the certain atmospheric condition.

14. The recording medium according to claim 13, wherein
the program causes the computer to further execute:
processing of training a model of machine learning by causing the model to learn the wavefronts of the laser light observed under the plurality of atmospheric conditions and atmospheric parameters individually representing the atmospheric conditions.

15. The recording medium according to claim 14, wherein
the program causes the computer to execute:
processing of inputting an atmospheric parameter representing a pseudo atmospheric condition to the model, and causing the model to output a pseudo wavefront of disturbed laser light.

16. The recording medium according to claim 15, wherein
the program causes the computer to execute:
processing of controlling adaptive optics to generate the pseudo wavefront of the disturbed laser light.

17. The recording medium according to claim 13, wherein
the generated pseudo wavefront of the laser light is utilized to test a performance of a communication system component using laser light.

18. The recording medium according to claim 13, wherein
the atmospheric parameter includes
at least one of:
a distance between a transmitting station and a receiving station for laser light;
types or performances of the transmitting station and the receiving station; and
weather information.
